(19) United States
(12) Patent Application Publication
(10) Pub. No.: US 2009/0265141 A1
(43) Pub. Date: Oct. 22, 2009

(54) DISTRIBUTED STORAGE IN WIRELESS SENSOR NETWORKS

(76) Inventors: Salah A. Aly, Cairo (EG); Zhenning Kong, New Haven, CT (US); Emina Soljanin, Green Village, NJ (US)

Correspondence Address: MARK W. SINCELL;Williams, Morgan & Amerson, P.C., Suite 1100, 10333 Richmond, Houston, TX, 77042, US

(21) Appl. No.: 12/167,510

(22) Filed: Jul. 3, 2008

Related U.S. Application Data
(60) Provisional application No. 61/046,643, filed on Apr. 21, 2008.

(51) Int. Cl. G06F 15/00

(52) U.S. Cl. 702/188

(57) ABSTRACT

The present invention provides a method for implementation in a first sensor node that is a member of a sensor node network including a plurality of sensor nodes. One embodiment of the method includes accessing, at the first sensor node, information indicative of a sensing operation performed by at least one of the plurality of sensor nodes. This embodiment of the method also includes randomly selecting, at the first sensor node, a second sensor node that is adjacent the first sensor node in the sensor node network. The random selection is made independent of a location of the second sensor node. This embodiment of the method further includes transmitting the information indicative of the sensing operation from the first sensor node to the second sensor node.

### CROSS REFERENCE TO RELATED APPLICATIONS

This application claims benefit of priority to U.S. Provisional Patent Application 61/046,643, filed on Apr. 21, 2008.

### BACKGROUND OF THE INVENTION

1. Field of the Invention

This invention relates generally to sensor systems, and, more particularly, to wireless sensor systems.

2. Description of the Related Art

Wireless sensor networks consist of small sensor devices (which may also be referred to as nodes) with limited resources. For example, a sensor device may include a sensing element, a small amount of CPU power, a relatively small power source such as a battery, a relatively small memory for storing data collected by the sensor, and a relatively small amount of network bandwidth for communicating the data to the network. The sensor devices can be deployed to monitor objects, measure temperature, detect fires and other disaster-related phenomena, and perform other measurements. The sensor devices are often deployed in isolated, hard to reach areas where human involvement is limited. Consequently, the data acquired by sensor nodes typically has a short lifetime and any processing of such data within the network should have low complexity and power consumption.

Although the sensor nodes in the network are typically capable of sensing data, storing data, and/or transmitting data to other sensor nodes, in some cases only a small number of the sensor nodes have collected or sensed information. For example, large-scale wireless sensor network may include a large number (n) of sensor nodes that includes a relatively small number (k<<n) of sensor nodes that have collected or sensed some information. The sensed data may be disseminated throughout the network of sensor nodes to reduce the likelihood that the data collected by one of the small number (k) of sensor nodes may be lost, e.g., due to failure of the sensor node. Dissemination of the sensed data may be particularly important when a limited energy budget and/or a hostile environment are likely to reduce the lifetime of each sensor node. For example, the collected information may be disseminated throughout the network so that each of the (n) sensor nodes stores one (possibly coded) packet. The packets may be disseminated so that the original (k) source packets can be recovered (i.e., decoded) using the packets that are stored in a small number of nearby nodes. For example, the distribution of source packets should allow the original source packets to be recovered using information stored in any set of (1+ε)k nodes, where ε is a small positive number.

Proposed techniques for disseminating sensor data throughout a network of sensor nodes combine a random walk distribution with traps at each of the source nodes. For example, one technique disseminates data by symmetric random walks with traps, where steps from one sensor node to another sensor node are made according to probabilities specified by the well known Metropolis algorithm. Each sensor node has to calculate how many copies of the information packet to send out, and each sensor node has to calculate its probability of trapping using the Metropolis algorithm. The total number of sensors (n) and the number of sources (k) must be specified in order to calculate the number of random walks initiated by each source sensor node. These parameters must also be specified in order to calculate the trapping probability at each sensor node. Additional global information, such as the maximum node degree and/or the maximum number of neighbors in the network, is also required to perform the Metropolis algorithm.

Examples of previously proposed techniques include the algorithm presented by Lin, et al, (Differentiated data persistence with priority random linear code, Proceedings of the 27th International Conference on Distribute Computing Systems, June, 2007) which studied the question “how to retrieve historical data that the sensors have gathered even if some sensors are destroyed or disappeared from the network?” Lin analyzed techniques to increase persistence of sensed data in a random wireless sensor network and proposed decentralized algorithms using Fountain codes to guarantee the persistence and reliability of cached data on unreliable sensors. Lin used random walks to disseminate data from multiple sensors (sources) to the whole network. Based on the knowledge of the total number of sensors n and sources k, each source calculates the number of random walks it needs to initiate and each sensor calculates the number of source packets it needs to trap. In order to achieve some desired packet distribution, the transition probabilities of random walks are specified by the well known Metropolis algorithm.

Dimakis, et al. (Ubiquitous access to distributed data in large-scale sensor networks through decentralized erasure codes, Proceedings of 4th IEEE symposium on Information Processing in Sensor Networks, Los Angeles, Calif., April 2005) proposed a decentralized implementation of Fountain codes that uses geographic routing, where every node has to know its location. The motivation for using Fountain codes is their low decoding complexity. Also, one does not know in advance the degrees of the output nodes in this type of codes. The authors proposed a randomized algorithm that constructs Fountain codes over a grid network using only geographical knowledge of nodes and local randomized decisions. Fast random walks are used to disseminate source data to the storage nodes in the network.

Kamra, et al. (Data persistence in sensor networks: Towards optimal encoding for data recovery in partial network failures, Workshop on Mathematical Performance Modeling and Analysis, June 2005) proposed a technique called growth codes to increase data persistence in wireless sensor networks, namely, increase the amount of information that can be recovered at the sink. Growth coding is a linear technique in which information is encoded in an online distributed way with increasing degree of a storage node. Kamra showed that growth codes can increase the amount of information that can be recovered at any storage node at any time period whenever there is a failure in some other nodes. Kamra did not use robust or soliton distributions, but proposed a new distribution depending on the network condition to determine degrees of the storage nodes.

Lin, et al. (Differentiated data persistence with priority random linear code, Proceedings of 27th International Conference on Distributed Computing Systems, Toronto Canada, June 2007) proposed decentralized algorithms to compute the minimum cost subgraphs for establishing multicast connections using network coding. Also, Lin addressed the problem of minimum-energy multicast in wireless networks as well as studying directed point-to-point multicast and evaluated the case of elastic rate demand.

The previously proposed dissemination techniques have a number of drawbacks. First, the Metropolis algorithm may not result in a distribution of information that results in each node storing a coded packet that corresponds to the contents of a coded packet that was formed by applying centralized Luby Transform (LT) coding to the collected data in the source data packets. Consequently, it may not be possible to decode the stored information and, if it is possible to decode the stored information, the encoding and/or decoding complexities may not be linear and may therefore consume a larger amount of energy than a linear encoding and/or decoding process such as centralized Luby Transform (LT) coding/decoding. Moreover, global information, such as the numbers of sensors and sources, the maximum node degree, the maximum number of neighbors, and the like may be difficult or impossible to determine for a large-scale sensor network, particularly if the topology of the network can change, e.g., due to sensor failure or the addition of sensors to the network. The conventional algorithms also assume that each sensor node only encodes data after receiving a sufficient number of source packets. Consequently, each sensor node must maintain a temporary memory buffer that is large enough to store the received information.

### SUMMARY OF THE INVENTION

The disclosed subject matter is directed to addressing the effects of one or more of the problems set forth above. The following presents a simplified summary of the disclosed subject matter in order to provide a basic understanding of some aspects of the disclosed subject matter. This summary is not an exhaustive overview of the disclosed subject matter. It is not intended to identify key or critical elements of the disclosed subject matter or to delineate the scope of the disclosed subject matter. Its sole purpose is to present some concepts in a simplified form as a prelude to the more detailed description that is discussed later.

In one embodiment, a method is provided for implementation in a first sensor node that is a member of a sensor node network including a plurality of sensor nodes. One embodiment of the method includes accessing, at the first sensor node, information indicative of a sensing operation performed by at least one of the plurality of sensor nodes. This embodiment of the method also includes randomly selecting, at the first sensor node, a second sensor node that is adjacent the first sensor node in the sensor node network. The random selection is made independent of a location of the second sensor node. This embodiment of the method further includes transmitting the information indicative of the sensing operation from the first sensor node to the second sensor node.

### BRIEF DESCRIPTION OF THE DRAWINGS

The disclosed subject matter may be understood by reference to the following description taken in conjunction with the accompanying drawings, in which like reference numerals identify like elements, and in which:

FIG. 1 conceptually illustrates a wireless sensor network;

FIG. 2 conceptually illustrates the encoding operations used for Fountain codes;

FIGS. 3A and 3B depict comparisons of the code degree distribution generated by the algorithms described herein and ideal distributions;

FIGS. 4-9 show the decoding performance of various algorithms;

FIG. 10 and FIG. 11 show the histograms of the estimation results of n and k of each node for various scenarios; and

FIG. 12 shows the decoding performance of the LTCDS-II algorithm with different values of the system parameter.

While the disclosed subject matter is susceptible to various modifications and alternative forms, specific embodiments thereof have been shown by way of example in the drawings and are herein described in detail. It should be understood, however, that the description herein of specific embodiments is not intended to limit the disclosed subject matter to the particular forms disclosed, but on the contrary, the intention is to cover all modifications, equivalents, and alternatives falling within the scope of the appended claims.

### DETAILED DESCRIPTION OF SPECIFIC EMBODIMENTS

Illustrative embodiments are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The disclosed subject matter will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the disclosed subject matter. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

The techniques described herein include methods to disseminate data acquired by a small number K of sensor nodes (sources) so that the data is redundantly distributed throughout the network to nodes in the network. At the end of the dissemination process process, the K originally acquired pieces of information can be recovered from a collection of nodes of a size that is slightly larger than K, with low computational complexity. The main advantages of such data dissemination are prolonged lifetime, increased spatial availability, as well as computationally and spatially easy access to the acquired data.

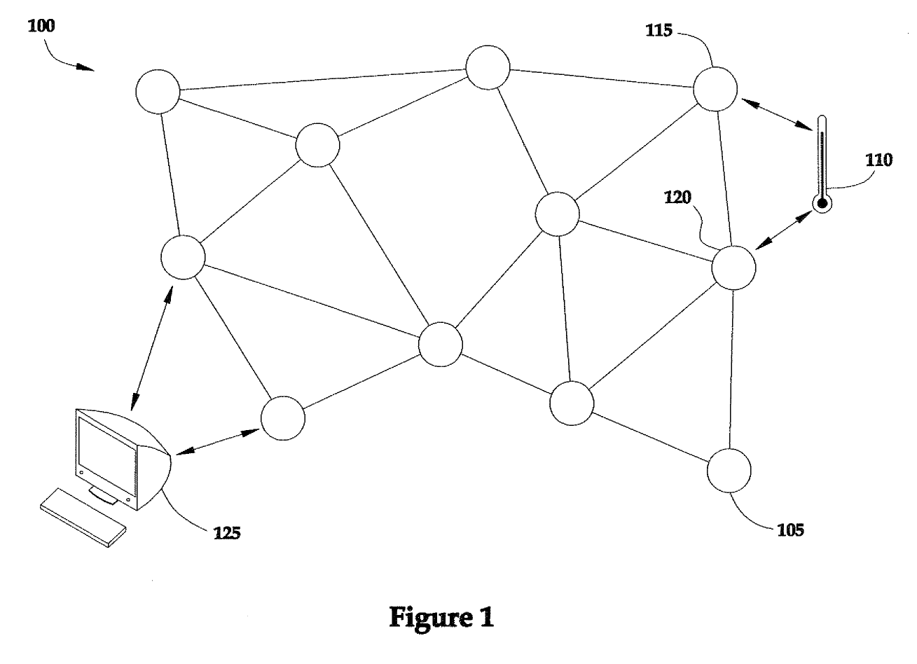

FIG. 1 conceptually illustrates one exemplary embodiment of a wireless sensor network 100. In the illustrated embodiment, the wireless sensor network 100 includes sensors 105 that may be distributed at locations throughout a geographic area. In the interest of clarity, only one of the sensors 105 has been specifically indicated by the 105 in FIG. 1. Other sensors 105 may be highlighted using different numerals. Furthermore, persons of ordinary skill in the art having benefit of the present disclosure should appreciate that the sensors 105 may be identical in one embodiment but may alternatively be a heterogeneous collection of different types of sensors 105. The sensors 105 shown in FIG. 1 may be used to monitor any type of measurable quantity including objects, environmental conditions such as temperatures, conditions related to fires and other disaster phenomena, and the like. For example, the sensors 105 may be used to measure a temperature proximate one or more of the sensors 105, as indicated by the thermometer symbol 110. However, persons of ordinary skill in the art having benefit of the present disclosure should appreciate that the thermometer symbol 110 is intended to be illustrative of a measurable quantity and not to limit the scope of the subject matter described herein.

In the illustrated embodiment, the sensors 115, 120 perform the measurements of the temperature indicated by the thermometer symbol 110 and store the information indicating the results of these measurements. The information indicative of the temperature (or other measured quantity) collected by the sensors 115, 120 is then distributed throughout the wireless sensor network 100 so that users that have access to the wireless sensor network 100, such as users that can access the wireless sensor network 100 through the workstation 125, can access the collected information from sensors 105 that are proximate the workstation 125. Distributing the information has the additional advantage that the information may be preserved even if one or more of the sensors 115, 120 is disabled or otherwise becomes unavailable. For example, the sensor 115 may be removed from or disconnected from the wireless sensor network 100, as indicated by the dotted lines. The information collected by the sensor 115 may nevertheless be available in other sensors 105 because this information has been distributed.

The wireless sensor network 100 includes n sensor nodes 105 out of which k nodes 105 are in possession of k information packets. The information packets may have been sensed or collected in some other way by the k sensor nodes 105. The packets are then distributed so that each of the n sensor nodes 105 stores one (possibly coded) packet and the original k source packets can be recovered later in a computationally simple way from any k(1+ε)nodes 105, where ε>0 is a relatively small value. The distribution algorithms are based on a simple random walk and Fountain codes. In contrast to other proposed distribution schemes, the algorithms described herein distribute information to the sensor nodes 105 but the sensor nodes 105 may not know global information such as the total number of nodes, the number of nodes that sensed were collected the original packets, or how the sensor nodes 105 are interconnected. For example, the sensor nodes 105 do not maintain any routing tables that indicate the interconnections of the various sensor nodes 105. One embodiment of the distribution algorithm may be referred to as LT-Codes based Distributed Storage-I (LTCDS-I) and another embodiment may be referred to as LT-Codes based Distributed Storage-II (LTCDS-II).

The various embodiments of the distribution algorithm use simple random walks without trapping to disseminate source packets. In contrast to other proposed methods, the embodiments of the distribution algorithm described herein demand little global information and memory at each sensor 105. For example, in LTCDS-I, only the values of n and k are needed, whereas the maximum node degree, which is more difficult to obtain, is not required. In LTCDS-TI, no sensor 105 needs to know any global information (e.g., the sensors 105 due not need to know n and k). Instead, sensors 105 can obtain estimates for those parameters by using properties of random walks. Moreover, in embodiments of the distribution algorithm described herein, each sensor makes decisions and performs encoding online upon each reception of the source packets instead of waiting until all the necessary source packets are collected to do encoding. This mechanism reduces the memory demand significantly.

In the illustrated embodiment, the wireless sensor network 100 consists of n nodes 105 that are uniformly distributed at random in a region TA=[L, L]² for L>1. The density of the network is given by

$$λ = \frac{n}{\vert A \vert} = \frac{n}{{L}^{2}} ,$$

where |A| is the two-dimensional Lebesgue measure (or area) of A. Each sensor node 105 has an identical communication radius of 1; thus any two nodes 105 can communicate with each other if and only if their distance is less than or equal to 1. This model is known in the art and conventionally referred to as a random geometric graph. Among the n nodes 105, there are k source nodes that have information to be disseminated throughout the network for storage. The k nodes 105 are uniformly and independently distributed at random among the n nodes 105. Usually, the fraction of source nodes 105, i.e., k/n, is not very large (e.g., 10%, or 20%). Note that, although the nodes 105 are uniformly distributed at random in a region, embodiments of the algorithms described herein and the results of applying these algorithms do not rely on this assumption and can be applied for any network topology, for example, regular grids.

The sensor nodes 105 may have no knowledge about the locations of other nodes 105 and no routing table may be maintained. Consequently, distribution algorithms that utilize routing tables or other mapping information that indicates the locations of the nodes 105 cannot be applied to distributing information amongst these sensor nodes 105. Moreover, each node 105 has limited (or no) knowledge of global information, but each node 105 is aware of which nodes 105 are its neighbors. The limited global information refers to the total numbers of nodes n and sources k. Any further global information, for example the maximal number of neighbors in the network, may not be available. Hence, algorithms that require this information cannot be used to distribute information among the sensor nodes 105.

Based on this model of the network 100, the term “node degree” may be defined as:

(Node Degree) Consider a graph G=(V,E), where V and E denote the set of nodes and links, respectively. Given u, υ, ε V, we say u and υ are adjacent (or u is adjacent to υ, and vice versa) if there exists a link between u and υ, i.e., (u,υ) ε E. In this case, we also say that u and υ are neighbors. Denote by N(u) the set of neighbors of a node u. The number of neighbors of a node u is called the node degree of u, and denoted by dₙ(u), i.e., |N(u)|=dₙ(u). The mean degree of a graph G is then given by

$$μ = \frac{1}{\vert V \vert} {\sum }_{u ∈ G = }^{ } {d}_{n} ( u ) , \qquad ( 1 )$$

where |V| is the total number of nodes in G.

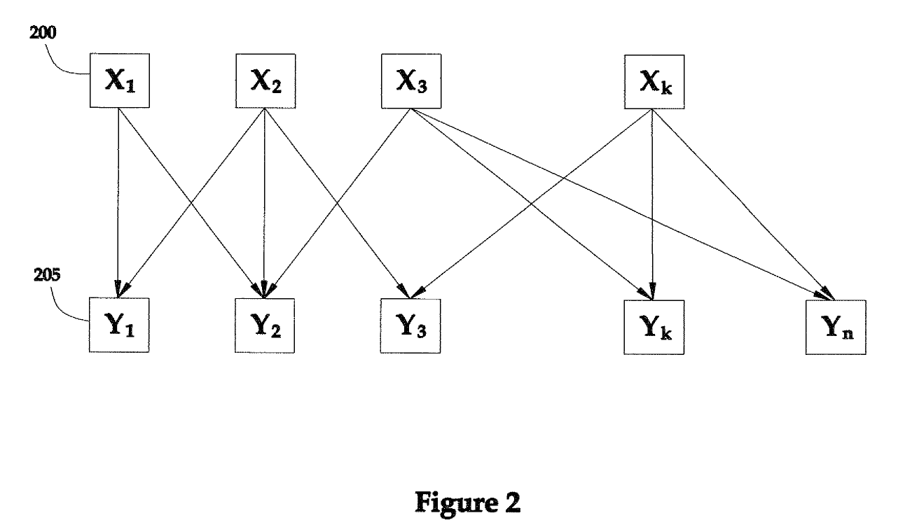

FIG. 2 conceptually illustrates the encoding operations used for Fountain codes. In the illustrated embodiment, each output 205 is obtained by performing an exclusive-or (XOR) operation on selected source blocks 200. The source blocks 200 are chosen uniformly and independently at random from the k source inputs. The number of source blocks 200 that are selected is chosen according to a probability distribution Ω(d). For k source blocks {χ₁, χ₂, . . . χₖ} and a probability distribution Ω(d) with 1≦d≦k, a Fountain code with parameters (k,Ω) is a potentially limitless stream of output blocks {y₁, y₂, . . . }. Fountain codes are rateless and one of their main advantages is that the encoding operations can be performed online. The encoding cost is the expected number of operations sufficient for generating an output symbol and the decoding cost is the expected number of operations sufficient to recover the k input blocks. Another advantage of Fountain codes, as opposed to purely random codes, is that their decoding complexity can be made low by appropriate choice of Ω(d), with little sacrifice in performance. The decoding of Fountain codes can be done by message passing.

Based on this definition of the Fountain codes, the term “code degree” may be defined as:

(Code Degree) For Fountain codes, the number of source blocks used to generate an encoded output y is called the code degree of y, and denoted by d_{c}(y). By constraction, the code degree distribution Ω(d) is the probability distribution of d_{c}(y).
LT (Luby Transform) codes are a special class of Fountain codes which uses known Ideal Soliton or Robust Soliton distributions. The Ideal Soliton distribution Ωᵢₛ(d) for k source blocks is given by

$${Ω}_{is} ( i ) = Pr ( d = i ) = \{ \begin{matrix}\frac{1}{k} , & i = 1 \\ \frac{1}{i ( i - 1 )} , & i = 2 , 3 , … , k .\end{matrix}$$

Let R=c₀\sqrt{k}ln(k/δ), where c₀ is a suitable constant and 0<δ<1. The Robust Soliton distribution for k source blocks is defined as follows. Define

$$τ ( i ) = \{ \begin{matrix}\frac{R}{ik} , & i = 1 , … , \frac{k}{R} - 1 \\ \frac{R ln ( R / δ )}{k} , & i = \frac{k}{R} , \\ 0 , & i = \frac{k}{R} + 1 , … , k ,\end{matrix} \\ and let β = {\sum }_{i = 1}^{k} τ ( k ) + {Ω}_{is} ( i ) .$$

The Robust Soliton distribution is given by

$${Ω}_{rs} ( i ) = \frac{τ ( i ) + {Ω}_{is} ( i )}{β} , for all i = 1 , 2 , … , k$$

The following result provides the performance of the LT codes with Robust Soliton distribution.
[Luby [?]] For LT codes with Robust Soliton distribution, k original source blocks can be recovered from any k+O(\sqrt{k}ln²(k/δ)) encoded output blocks with probability 1−δ. Both encoding and decoding complexity is O(k ln(k/δ)).

A first exemplary embodiment of a distribution algorithm (referred to herein as LTCDS-T) disseminates source packets throughout the wireless sensor network 100 by a simple random walk. Each node 105 in the network 100 is aware of the total number of sources in the network and the total number of nodes 105. The nodes 105 do not need to know the maximum degree of the graph. The dissemination process proceeds iteratively. At each round, each node u that has packets to transmit chooses one node υ among its neighbors uniformly independently at random, and sends the packet to the node υ. In order to avoid the local-cluster effect—in which each source packet is trapped most likely by its neighbor nodes—each node accepts a source packet equiprobably. To achieve this, each source packet visits each node in the network at least once.

For a random walk on a graph, the “cover time” is defined as follows:
(Cover Time) Given a graph G, let T_{cover}(u) be the expected length of a random walk that starts at node u and visits every node in G at least once. The cover time of G is defined by

$${T}_{cover} ( G ) = {max}_{u ∈ G} {T}_{cover} ( u ) . \qquad ( 1 )$$

For a simple random walk on a random geometric graph, the following result bounds the cover time.
[Avin and Ercal [?]] If a random geometric graph with n nodes is a connected graph with high probability, then

T_{cover}(G)=⊖(n log n). (1)

As a result of the cover time, a counter for each source packet can be set and increased by one after each forward transmission until the counter reaches some threshold C₁n log n to guarantee that the source packet visits each node in the network at least once.

[(i)]

Initialization Phase: [(1)]

Each node u in the network draws a random number d_{c}(u) according to the distribution Ωᵢₛ(d) given by (??) (or Ωᵣₛ(d) given by (??)). Each source node sᵢ, i=1, . . . , k generates a header for its source packet χₛ_{ᵢ} and puts its ID and a counter c(χₛ_{ᵢ}) with the initial value zero into the packet header. We set up tokens for initial and update packets. We assume that a token is set to zero for and initial packet and 1 for an update packet.

packetₛ_{ᵢ}=(IDₛ_{ᵢ}, χₛ_{ᵢ}, c(χₛ_{ᵢ}))

Each source node sᵢ sends out its own source packet χₛ_{ᵢ} to another node u which is chosen uniformly at random among all its neighbors N(sᵢ).

The chosen node u accepts this source packetₛ_{ᵢ} with probability

$$\frac{{d}_{c} ( u )}{k}$$

and updates its storage as

yᵤ⁺=yᵤ⁻⊕χₛ_{ᵢ}. (1)

where yᵤ⁻ and yᵤ⁺ denote the packet that the node u stores before and after the updating, respectively, and ⊕ represents XOR operation. No matter whether the source packet is accepted or not, the node u puts it into its forward queue and set the counter of χₛ_{ᵢ} as

c(χₛ_{ᵢ})=1. (2)

The encoding phase may be performed as follows:

[(1)]

In each round, when a node u receives at least one source packet before the current round, u forwards the head-of-line (HOL) packet χ in its forward queue to one of its neighbor υ, chosen uniformly at random among all its neighbors N(u).

Depending on how many times χ visits υ, the node υ makes its decisions: [•]

If it is the first time that χ visits υ, then the node υ accepts this source packet with probability d/k and updates its storage as

y_{υ}⁺=y_{υ}⁻⊕χ. (1)

If χ has visited υ before and c(χ)<C₁n log n where C₁ is a system parameter, then the node υ accepts this source packet with probability 0.

No matter χ is accepted or not, the node υ puts it into its forward queue and increases the counter of χ by one:

c(χ)=c(χ)+1. (2)

If χ has visited υ before c(χ)≦Cₗn log n then the node υ discards the packet χ0 forever.

When a node u makes its decisions for all the source packets χₛ_{₁}, χₛ_{₂}, . . . , χₛ_{ₖ}, i.e., all these packets have visited the node u at least once, the node u finishes its encoding process by declaring the current yᵤ to be its storage packet.

The pseudo-code for the LTCDS-I algorithm may be written as follows:

| | |
|---|---|
| | 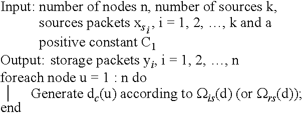 |
| | 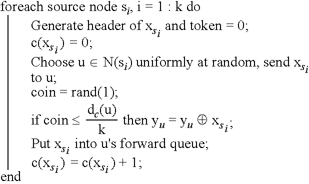 |
| | 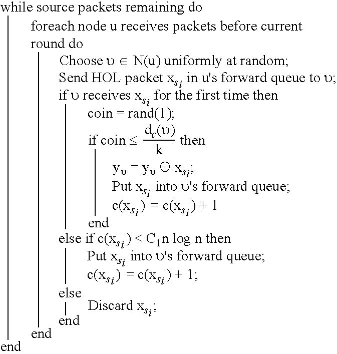 |
| C | |

The following theorem (Theorem 1) establishes the code degree distribution of each storage node induced by the LTCDS-I algorithm:

When a sensor network with n nodes and k sources finishes the storage phase of the LTCDS-I algorithm, the code degree distribution of each storage node u is given by

$$Pr ( {\hat{d}}_{c} ( u ) = i ) = {\sum }_{{d}_{c} ( u ) = 1}^{k} ( \begin{matrix}k \\ i\end{matrix} ) {( \frac{{d}_{c} ( u )}{k} )}^{i} {( 1 - \frac{{d}_{c} ( u )}{k} )}^{k - 1} {Ω}^{′} ( {d}_{c} ( u ) ) , \qquad ( 1 )$$

where d_{c}(u) is given in the initialization phase of the LTCDS-I algorithm from distribution Ω′(d) (i.e., Ωᵢₛ(d) or Ωᵣₛ(d)), and \tilde{d}_{c}(u) is the code degree of the node u resulting from the algorithm.

For each u, d_{c}(u) is drawn from a distribution Ω′(d) (i.e., Ωᵢₛ(d) or Ωᵣₛ(d)). Given d_{c}(u), the node u accepts each source packet with probability

$$\frac{{d}_{c} ( u )}{k}$$

independently of each other and d_{c}(u). Thus, the number of source packets that the node u accepts follows a Binomial distribution with parameter

$$\frac{{d}_{c} ( u )}{k} .$$

### Hence,

$$\begin{matrix}Pr ( {\tilde{d}}_{c} ( u ) = i ) = {\sum }_{{d}_{c} ( u ) = 1}^{k} Pr ( {\tilde{d}}_{c} ( u ) = i \vert {d}_{c} ( u ) ) {Ω}^{′} ( {d}_{c} ( u ) \\ = {\sum }_{{d}_{c} ( u ) = 1}^{k} ( \begin{matrix}k \\ i\end{matrix} ) {( \frac{{d}_{c} ( u )}{k} )}^{i} {( 1 - \frac{{d}_{c} ( u )}{k} )}^{k - i} {Ω}^{′} ( {d}_{c} ( u ) ) ,\end{matrix}$$

and thereafter (?48 ) holds.

Theorem 1 indicates that the code degree \tilde{d}_{c}(u) is not the same as d_{c}(u). In fact, one may achieve the exact desired code degree distribution by letting all the sensors hold the received source packets in their temporary buffer until they collect all k source packets. Then the sensors can randomly choose d_{c}(u) packets. In this way, the resulting degree distribution is exactly the same as Ωᵢₛ or Ωᵣₛ. However, this requires that each sensor has enough buffer or memory, which is usually not practical, especially when k is large. Therefore, in LTCDS-I, each sensor may be assumed to have very limited memory and they may make their decision upon each reception.

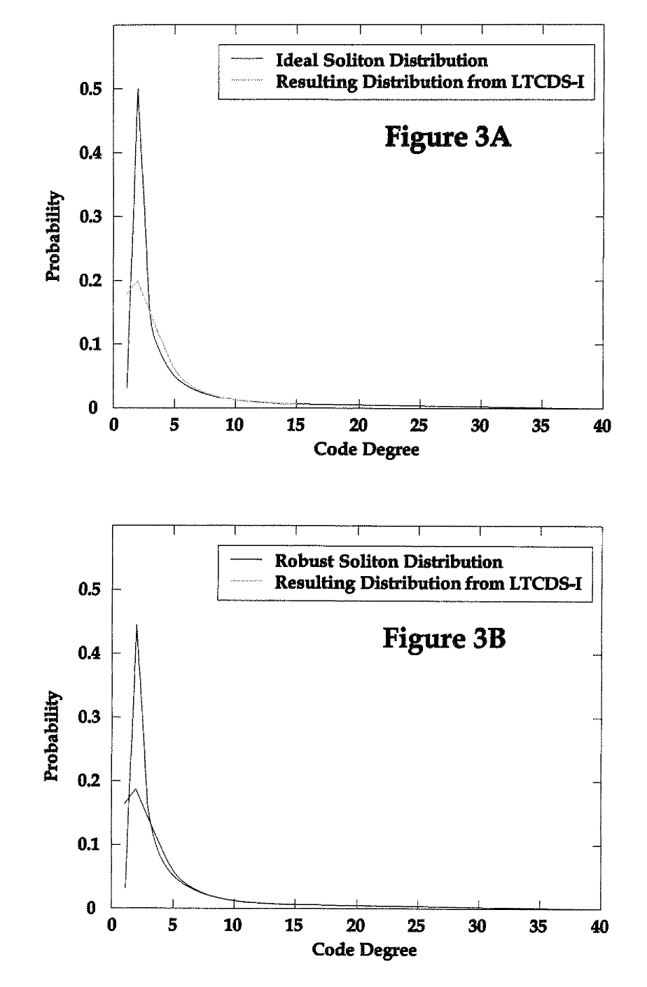

FIGS. 3A and 3B depict comparisons of the code degree distribution generated by the algorithms described herein and ideal distributions. FIG. 3A compares the Ideal Soliton distribution and the resulting degree distribution from the LTCDS-I algorithm. FIG. 3B compares the Robust Soliton distribution and the resulting degree distribution from LTCDS-I algorithm. At the high degree end of the comparison graphs, the code degree distribution obtained by the LTCDS-I algorithm perfectly matches the desired code degree distribution, i.e., either the Ideal Soliton distribution Ωᵢₛ or the Robust Soliton distribution Ωᵣₛ. For the resulting degree distribution and the desired degree distributions, the difference only lies at the low degree end, especially at degree 1 and degree 2. In particular, the resulting degree distribution has higher probability at degree 1 and lower probability at degree 2 than the desired degree distributions. The higher probability at degree 1 turns out to compensate the lower probability at degree 2 so that the resulting degree distribution has very similar encoding and decoding behavior as LT codes using either the Ideal Soliton distribution or the Robust Soliton distribution.

The following theorem (Theorem 2) demonstrates the relationship between the decoding performance of the LTCDS-I algorithm and conventional LT coding:

Suppose sensor networks have n nodes and k sources and the LTCDS-I algorithm uses the Robust Soliton distribution Ωᵣₛ. Then, when n and k are sufficient large, the k original source packets can be recovered from any k+O(\sqrt{k}ln²(k/δ)) storage nodes with probability 1−δ. The decoding complexity is O(k ln(k/δ)).

Another performance metric is the transmission cost of the algorithm, which is characterized by the total number of transmissions (the total number of steps of k random walks). The total number of transmissions for this algorithm is given by the theorem (Theorem 3):

Denote by T_{LTCDS}^{(I)} the total number of transmissions of the LTCDS-I algorithm, then we have

T_{LTCDS}^{(I)}=⊖(k n log n). (1)

where k is the total number of sources, and n is the total number of nodes in the network.

Theorem 3 can be proved by noting that each of the k source packets is stopped and discarded if and only if it has been forwarded for C₁n·log(n) times for some value of the constant C₁. Then the total number of transmissions of the LTCDS-I algorithm for all k source packet is a direct consequence and is given by the above theorem.

A second exemplary embodiment of a distribution algorithm (referred to herein as LTCDS-II) also disseminates source packets throughout the wireless sensor network 100 by a simple random walk. However, in contrast to the first exemplary embodiment (LTCDS-I), each node 105 in the network 100 is not aware of the total number of sources in the network and the total number of nodes 105. Instead, properties of random walks are used to infer estimates of the total number of sources in the network and the total number of nodes 105.

An “inter-visit time” for a collection of nodes 105 can be defined as:

(Inter-Visit Time) For a random walk on a graph, the inter-visit time of node u. Tᵥᵢₛᵢₜ(u), is the amount of time between any two consecutive visits of the random walk to node u. This inter-visit time is also called return time.

For a simple random walk on random geometric graphs, the following lemma (Lemma 1) provides results on the expected inter-visit time of any node:

For a node u with node degree dₙ(u) in a random geometric graph, the mean inter-visit time is given by

$$E [ {T}_{visit} ( u ) ] = \frac{μ n}{{d}_{n} ( u )} , \qquad ( 1 )$$

where μ is the mean degree of the graph given by Equation(??).

The proof is straightforward by following the standard result of stationary distribution of a simple random walk on graphs and the mean return time for a Markov chain. Lemma 1 demonstrates that if each node (a can measure the expected inter-visit time E[Tᵥᵢₛᵢₜ(u)], then the total number of nodes n can be estimated by

$$n = \frac{{d}_{n} ( u ) E [ {T}_{visit} ( u ) ]}{μ} .$$

However, the mean degree if is global information and may be hard to obtain. Thus, a further approximation can be made in which the estimate of n by the node u is given by:

\hat{n}(u)=E[Tᵥᵢₛᵢₜ(u)].

Hence, every node u computes its own estimate of n. In embodiments of the distributed storage algorithms, each source packet follows a simple random walk. Since there are k sources, we have k individual simple random walks in the network. For a particular random walk, the behavior of the return time is characterized by Lemma 1 that provides the inter-visit time.

An inter-packet time can also be defined as the inter-visit time among all k random walks:

(Inter-Packet Time) For k random walks on a graph, the inter-packet time of node u, T_{packet}(u), is the amount of time between any two consecutive visits of those k random walks to node u.

The mean value of the inter-packets time is given by the following lemma (Lemma 2):

For a node u with node degree dₙ(u) in a random geometric graph with k simple random walks, the mean inter-packet time is given by

$$E [ {T}_{packet} ( u ) ] = \frac{E [ {T}_{visit} ( u ) ]}{k} = \frac{μ n}{{kd}_{n} ( u )} , \qquad ( 1 )$$

where μ is the mean degree of the graph given by (??).

The lemmas (Lemma 1 and Lemma 2) that provide the inter-visit time and the inter-packet time can be used to demonstrate that for any node u, an estimation of k can be obtained by

$$\hat{k} ( u ) = \frac{E [ {T}_{visit} ( u ) ]}{E [ {T}_{packet} ( u ) ]} . \qquad ( 2.1 .1 )$$

After obtaining estimates for both n and k, similar techniques can be used in LTCDS-I to do LT coding and storage.

The initialization phase of the second exemplary algorithm is given by:

[(1)]

### Initialization Phase: [(1)]

Each source node sᵢ, i=1, . . . k generates a header for its source packet χₛ_{ᵢ} and its ID and a counter c(χₛ_{ᵢ}) with initial value zero into the packet header.

Each source node sᵢ sends out its own source packet χₛ_{ᵢ} to one of its neighbors u, chosen uniformly at random among all its neighbors N(sᵢ).

The node u puts χₛ_{ᵢ} into its forward queue and sets the counter of χₛ_{ᵢ} as

c(χₛ_{ᵢ})=1. (1)

The inference phase of the second exemplary embodiment of the algorithm is given by:

[(1)]

For each node u, suppose χₛ₍ᵤ₎_{ᵢ} is the first source packet that visits u, and denote by tₛ₍ᵤ₎_{ᵢ}^{(j)} the time when χₛ₍ᵤ₎_{ᵢ} has its j-th visit to the node u. Meanwhile, each node u also maintains a record of visiting time for each other source packet χₛ₍ᵤ₎_{ᵢ} that visited it. Let tₛ₍ᵤ₎_{ᵢ}^{(j)} be the time when source packet χₛ₍ᵤ₎_{ᵢ} has its j-th visit to the node u. After χₛ₍ᵤ₎_{_{i l visiting the node u C}}₂ times, where C₂ is the system parameter which is a positive constant, the node u stops this monitoring and recoding procedure. Denote by k(u) the number of source packets that have visited at least once upon that time.

For each node u, let J(s(u)ᵢ) be the number of visits of source packet χₛ₍ᵤ₎_{ᵢ} to the node u and let

$$\begin{matrix}{T}_{{s ( u )}_{i}} = \frac{1}{J ( {s ( u )}_{i} )} {\sum }_{j = 1}^{J ( {s ( u )}_{i} )} {t}_{{s ( u )}_{i}}^{( j + 1 )} - {t}_{{s ( u )}_{i}}^{( j )} \\ = \frac{1}{J ( {s ( u )}_{i} )} ( {t}_{{s ( u )}_{i}}^{( J ( {s ( u )}_{i} ) )} - {t}_{{s ( u )}_{i}}^{( 1 )} ) .\end{matrix}$$

Then, the average inter-visit time for node u is given by

$${\tilde{T}}_{visit} ( u ) = \frac{1}{k ( u )} {\sum }_{i = 1}^{k ( u )} {T}_{{s ( u )}_{i}} . \qquad ( 1 )$$

Let Jₘᵢₙ=minₛ₍ᵤ₎_{ᵢ}{fₛ₍ᵤ₎_{ᵢ}⁽¹⁾} and Jₘₐₓ=maxₛ₍ᵤ₎_{ᵢ}{tₛ₍ᵤ₎_{ᵢ}^{(J(s(u)}_{ⁱ⁾⁾}}, then the inter-packet time is given by

$${\tilde{T}}_{packet} ( u ) = \frac{{J}_{min} - {J}_{max}}{{\sum }_{s ( u ) ,} J ( {s ( u )}_{i} )} . \qquad ( 2 )$$

Then the node u can estimate the total number of nodes in the network and the total number of sources as

$$\begin{matrix}\hat{n} ( u ) = {\tilde{T}}_{visit} ( u ) , and & ( 3 ) \\ \hat{k} ( u ) = \frac{{\tilde{T}}_{visit} ( u )}{{\tilde{T}}_{packet} ( u )} . & ( 4 )\end{matrix}$$

In this phase, the counter c(χₛ_{ᵢ₎} of each source packet c(χₛ_{ᵢ}) is incremented by one after each transmission.

The encoding phase of the second exemplary embodiment of the algorithm is given by the following. When a node u obtains estimates \hat{n}(u) and \hat{k}(u), it begins encoding phase which is the same as the one in LTCDS-I Algorithm except that the code degree d_{c}(u) is drawn from distribution χᵢₛ(d) (or Ωᵣₛ(dₗ) with replacement of k by k(u), and a source packet χₛ_{ᵢ} is discarded if c(χₛ_{ᵢ})≦C₃\hat{n}(u) log \hat{n}(u), where C₃ is a system parameter which is a positive constant.

When a node u has made its decisions for \hat{k} source packets, it finishes its encoding process and yᵤ becomes the storage packet of u. The total number of transmissions (the total number of steps of k random walks) in the LTCDS-II algorithm has the same order as LTCDS-I, as indicated by the theorem below (Theorem 4):

Denote by T_{LTCDS}^{(II)} the total number of transmissions of the LTCDS-II algorithm, then we have

T_{LTCDS}^{(II)}=⊖(kn log n). (1)

where k is the total number of sources, and n is the total number of nodes in the network.
The proof of Theorem 4 is as follows:

In the interference phase of the LTCDS-II algorithm, the total number of transmissions is upper bounded C′n for some constants C′<0. That is because each node needs to receive the first visit source packet for C₂ times, and by Lemma ??, the mean inter-visit time is ⊖(n).

In the decoding phase, the same as in the LTCDS-I algorithm, in order to guarantee that each source packet visits all the nodes at least once, the number of steps of the simple random walk is ⊖(n log n). In other words, each source packet is stopped and discarded if and only if the counter reaches the threshold C₃n log(n) for some system parameter C₃. Therefore, we have (??).

Once the storage nodes 105 have stored values associated with the various packets collected by the source nodes 105, the data may be updated. In the illustrated embodiment, data is updated after all storage nodes saved their values y₁, y₂, . . . yᵤ, but a sensor node, say sᵢ, wants to update its value to the appropriate set of storage nodes in the network. The following updating algorithm applies for both LTCDS-I and LTCDS-II. For simplicity, we illustrate the idea with LTCDS-I.

Assume the sensor node prepared a packet with its ID, old data χₛ_{ᵢ}, new data χ′ₛ_{ᵢ} along with a time-to-live parameter c(sᵢ) initialized to zero. A simple random walk may be used for data update.

packetₛ_{ᵢ}=(IDₛ_{ᵢ}, χ_{z}_{ᵢ}⊕χ′ₛ_{ᵢ}, c(sᵢ)). (2.2.1)

The storage nodes keep ID's of the accepted packets and so an iteration of a random walk can be run and each node can check for the packet's ID. Assume the node u keeps track of all ID's of its accepted packets. Then the node as accepts the updated message if ID of the packet is already included in the u's ID list. Otherwise u forwards the packet and increments the time-to-live counter. If this counter reaches the threshold value, then the packet will be discarded.

The following steps describe one exemplary embodiment of the update scenario:

[(i)]

Preparation Phase:

The node sᵢ prepares its new packet with the new and old data along with its ID and counter. Also sᵢ add an update counter token initialized at 1 for the first updated packet. So, we assume that the following steps happen when token is set to 1.

packetₛ_{ᵢ}=(IDₛ_{ᵢ}χₛ_{ᵢ}⊕χ′ₛ_{ᵢ}, c(sᵢ)). (1)

sᵢ chooses at random a neighbor node u, and sends its packetₛᵢ.

Encoding Phase:

The node u checks if the packetₛ_{ᵢ} is an update or first-time packet. If it is first-time packet is will accept, forward, or discard it as shown in LTCDS-I algorithm ??. If packetₛ_{ᵢ} is an updated packet, then the node u will check if IDₛ_{ᵢ} is already included in its accepted list. If yes, then if will update its value yᵤ as follows.

yᵤ⁺=yᵤ^{-⊕χ}ₛ_{ᵢ}⊕χ′ₛ_{ᵢ}. (2)

If no, it will add this updated packet into its forward queue with incrementing the counter

c(χ′ₛ_{ᵢ})=c(χ′ₛ_{ᵢ})+1. (3)

The packetₛ_{ᵢ} will be discarded if c(χ′ₛ_{ᵢ})≦C₁n log n where C₁ is a system parameter. In this case, we need C₁ to be large enough, so all old data χₛ_{ᵢ} will be updated to the new data χ′ₛ_{ᵢ}.

Storage Phase:

If all nodes are done with updating their values yᵢ. One can run the decoding phase to retrieve the original and update information.

If one random walk is performed for each update, and if h is the number of nodes updating their values, then we have the following result:

The total number of transmissions needed for the update process is bounded by ⊖(hn log n).

The performance of embodiments of the algorithms described herein may be evaluated by simulating the wireless sensor network 100. The performance evaluations use the following definitions. The “decoding ratio” is defined as:

(Decoding Ratio) Decoding ratio η is the ratio between the number of queried nodes h and the number of sources k, i.e.,

$$η = \frac{h}{k} . \qquad ( 1 )$$

The successful decoding probability may also be defined as:

(Successful Decoding Probability) Successful decoding probability Pₛ is the probability that the k source packets are all recovered from the h querying nodes.

In one embodiment of the simulation, Pₛ is evaluated as follows. Suppose the network has n nodes and k sources, and h nodes are queried. There are (ₕⁿ) ways to choose such h nodes, and one tenth of these choices may be selected uniformly at random:

$$M = \frac{1}{10} ( \begin{matrix}n \\ h\end{matrix} ) = \frac{n !}{10 \cdot h ! ( n - h ) !} .$$

Let Mₛ be the size of the subset these M choices of it query nodes from which the k source packets can be recovered. Then, the successful decoding probability is:

$${P}_{s} = \frac{{M}_{s}}{M} .$$

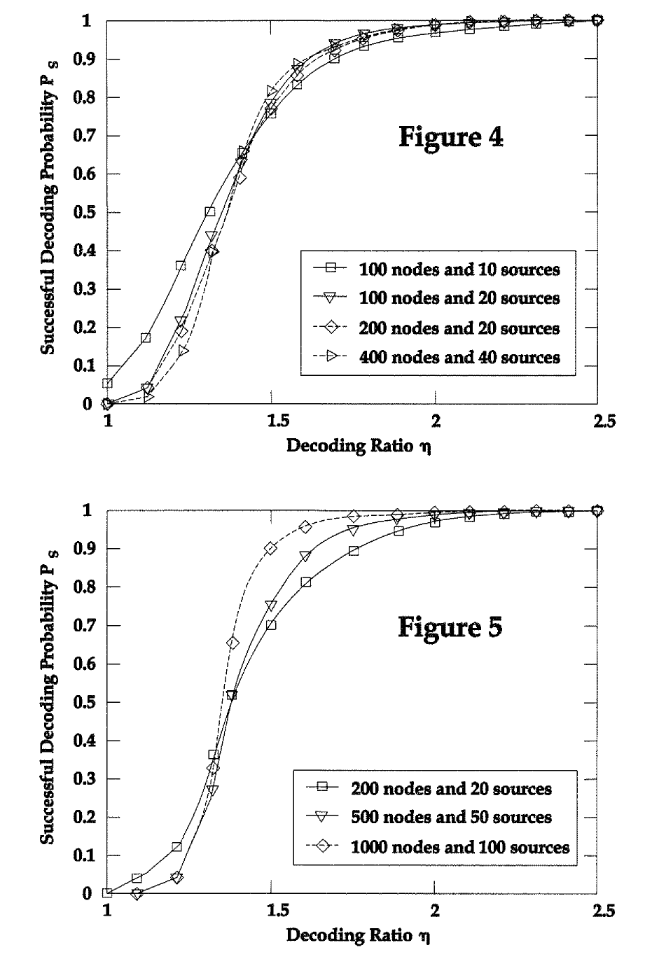

FIG. 4 shows the decoding performance of LTCDS-I algorithm with Ideal Soliton distribution with small number of nodes and sources. The network is deployed in A=[5,5]², and the system parameter C₁ is set as C₁=5. From the simulation results we can see that when the decoding ratio is above 2, the successful decoding probability is about 99%. Another observation is that when the total number of nodes increases but the ratio between k and n and the decoding ratio η are kept as constants, the successful decoding probability Pₛ increases when η≦1.5 and decreases when η<1.5. This is also confirmed by the results shown in FIG. 5. In FIG. 5, The network has constant density as

$$λ = \frac{40}{9}$$

and the system parameter C₁=3.

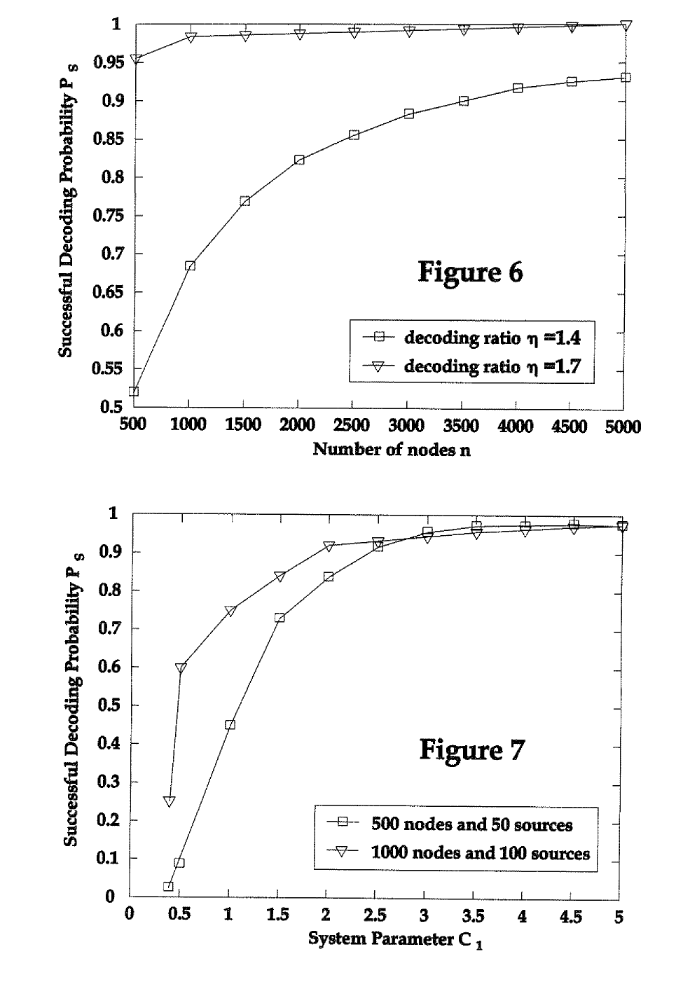

In FIG. 6, the decoding ratio η is fixed as 1.4 and 1.7, respectively, and the ratio between the number of sources and the number of nodes is set as 10%, i.e., k/n=0.1. The number of nodes n is changed from 500 to 5000. From the results shown in FIG. 6, it can be seen that as n grows, the successful decoding probability increases until it reaches some platform which is the successful decoding probability of real LT codes. This confirms that LTCDS-I algorithm has the same asymptotical performance as LT codes.

To investigate how the system parameter C₁ affects the decoding performance of the LTCDS-I algorithm, the decoding ratio η can be fixed and the system parameter C₁ can be varied. FIG. 7 shows the simulation results for a variable system parameter. For the scenario of 1000 nodes and 100 sources, η is set as 1.6, and for the scenario of 500 nodes and 50 sources, η is set as 1.8. The code degree distribution is also the Ideal Soliton distribution, and the network is deployed in A=[15,15]². It can be seen that when C₁≦3, Pₛ keeps almost like a constant, which indicates that after 3n log n steps, almost all source packets visit each node at least once.

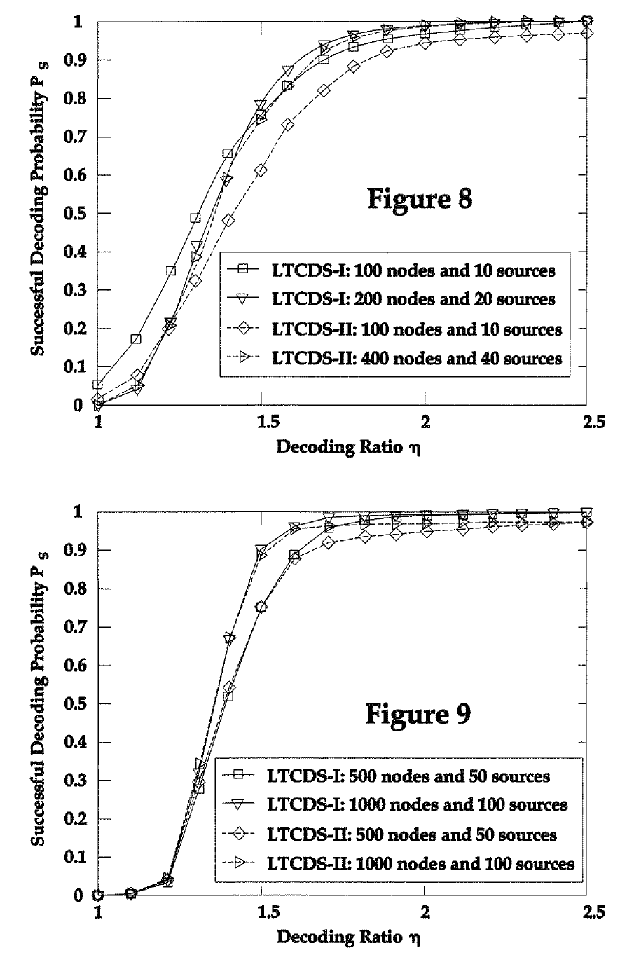

FIG. 8 compares the decoding performance of LTCDS-II and LTCDS-I with the Ideal Soliton distribution with small number of nodes and sources. As in FIG. 4, the network is deployed in A=[5,5]² and the system parameter is set as C₃=10. To guarantee that each node obtains accurate estimations of n and k, the system parameter is set to C₂=50. It can be seen that the decoding performance of the LTCDS-II algorithm is a little bit worse than the LTCDS-I algorithm when decoding ratio η is small, and almost the same when η is large.

FIG. 9 compares the decoding performance of LTCDS-II and LTCDS-I with Ideal Soliton distribution with medium number of nodes and sources, where the network has constant density as λ=40/0 and the system parameter C₃=20. Different phenomena can be seen in this comparison. The decoding performance of the LTCDS-II algorithm is a little bit better than the LTCDS-I algorithm when decoding ratio η is small, and almost the same when η is large. That is because for the simulation in FIG. 8, we set C₃=20 which is larger than C₃=10 set for the simulation in FIG. 7. The larger value of C₃ guarantees that each node has the chance to accept each source packet, which results in a more uniformly distribution.

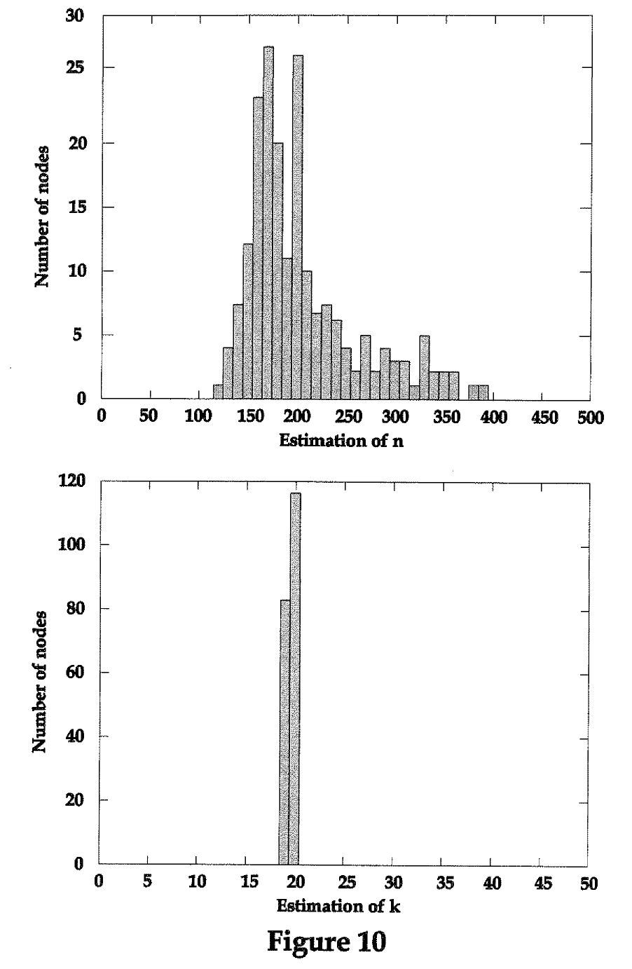

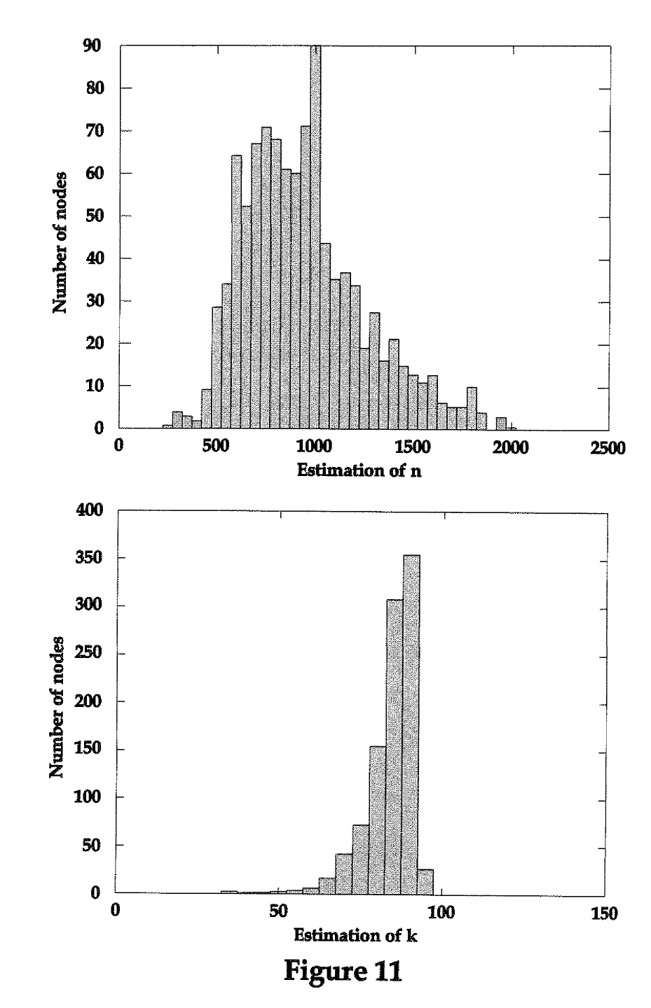

FIG. 10 and FIG. 11 show the histograms of the estimation results of η and k of each node for three scenarios: FIG. 10 shows the results for 200 nodes and 20 sources; and FIG. 11 shows the results for 1000 nodes and 100 sources. In the first two scenarios, set C₂=50. From the results one can see that the estimations of k are more accurate and concentrated than the estimations of n. This is because the estimation of k only depends on the ratio between the expected inter-visit time and the expected inter-packet time, which is independent of the mean degree μ and the node degree dₙ(u). On the other hand, the estimation of n depends on μ and dₙ(u). However, in the LTCDS-II algorithm, each node approximates μ as its own node degree dₙ(u), which causes the deviation of the estimations of n.

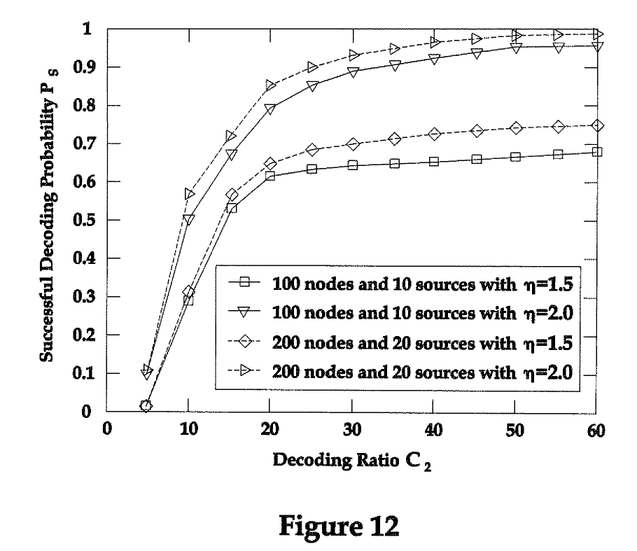

FIG. 12 shows the decoding performance of the LTCDS-II algorithm with different values of the system parameter. In the illustrated embodiment, the decoding ratio η and C₃ are fixed and the system parameter C₂ is varied. From the simulation results, one can see that when C₂ is chosen to be small, the performance of the LTCDS-II algorithm is very poor. This is due to the inaccurate estimations of k and n of each node. When C₂ is large, for example, when C₂≦30, the performance is almost the same.

Embodiments of the decentralized algorithms described herein utilize Fountain codes and random walks to distribute information sensed by k sensing source nodes to n storage nodes. These algorithms are simpler, more robust, and less constrained in comparison to previous solutions that require knowledge of network topology, maximum degree of a node, or knowing values of n and k. The computational encoding and decoding complexity of these algorithms was computed and the performance of the algorithms was simulated with small and large numbers of k and n nodes. It was demonstrated that a node can successfully estimate the number of sources and total number of nodes if it can only compute the inter-visit time and inter-packet time.

Portions of the disclosed subject matter and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the disclosed subject matter are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The disclosed subject matter is not limited by these aspects of any given implementation.

The particular embodiments disclosed above are illustrative only, as the disclosed subject matter may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed:

1. A method for implementation in a first sensor node that is a member of a sensor node network including a plurality of sensor nodes, comprising:
accessing, at the first sensor node, information indicative of a sensing operation performed by at least one of the plurality of sensor nodes;
randomly selecting, at the first sensor node, a second sensor node that is adjacent the first sensor node in the sensor node network, the random selection being made independent of a location of the second sensor node; and
transmitting the information indicative of the sensing operation from the first sensor node to the second sensor node.

2. The method of claim 1, wherein accessing the information indicative of the sensing operation performed by at least one of the plurality of sensor nodes comprises performing the sensing operation at the first sensor node.

3. The method of claim 2, comprising forming a packet including the information indicative of the sensing operation performed at the first sensor node.

4. The method of claim 3, wherein forming the packet comprises forming a packet including a header that comprises an identifier and a counter configured to be incremented each time the packet is transmitted.

5. The method of claim 1, wherein accessing the information indicative of the sensing operation performed by at least one of the plurality of sensor nodes comprises receiving, from a third sensor node, information indicative of the sensing operation performed by at least one of the plurality of sensor nodes in response to the third sensor node randomly selecting the first sensor node independent of a location of the first sensor node.

6. The method of claim 5, wherein receiving the information comprises receiving a packet including the information indicative of the sensing operation performed by at least one of the plurality of sensor nodes, an identifier, and a counter configured to be incremented each time the packet is transmitted.

7. The method of claim 6, wherein receiving the packet comprises incrementing the counter.

8. The method of claim 7, comprising discarding the packet when the incremented value of the counter exceeds a maximum counter value.

9. The method of claim 8, wherein receiving the packet comprises determining, in response to determining that the incremented value of the counter does not exceed the maximum counter value, whether to store the packet based on a random number selected from a predetermined distribution and a number of sensor nodes that have performed sensing operations.

10. The method of claim 9, wherein receiving the packet comprises determining whether the packet has been previously transmitted to the first sensor node, and wherein determining whether to store the packet comprises determining whether to store the packet based upon information indicative of a number of sensor nodes in the sensor node network.

11. The method of claim 10, comprising combining the packet with a previously stored packet including information indicative of the at least one previously received packet when the first sensor node determines that the packet is to be stored.

12. The method of claim 11, comprising iteratively accessing stored packets, randomly selecting adjacent sensor nodes, and transmitting the accessed packets to the randomly selected adjacent sensor nodes to generate a selected distribution of the information indicative of the sensing operation performed by at least one of the sensor nodes.

13. The method of claim 12, wherein generating the selected distribution comprises generating the selected distribution such that the information indicative of the sensing operation can be retrieved from a number of sensor nodes that is slightly larger than the number of sensor nodes that performed sensing operations used to generate the information.

14. The method of claim 13, comprising estimating the number of source nodes in the source node network based upon a time between a first visit and a second visit associated with the packet.

15. The method of claim 14, comprising estimating the number of sensor nodes that performed sensing operations based upon a time between consecutive visits of packets.

16. A sensor node that is configured to operate as a member of a sensor node network including a plurality of sensor nodes, the sensor node being configured to:
access information indicative of a sensing operation performed by at least one of the plurality of sensor nodes;
randomly select a second sensor node that is adjacent the sensor node in the sensor node network, the random selection being made independent of a location of the second sensor node; and
transmit the information indicative of the sensing operation to the second sensor node.

17. The sensor node of claim 16, wherein the sensor node is configured to perform the sensing operation and form a packet including the information indicative of results of the sensing operation.

18. The sensor node of claim 16, wherein the sensor node is configured to receive, from a third sensor node, information indicative of the sensing operation performed by at least one of the plurality of sensor nodes in response to the third sensor node randomly selecting the sensor node independent of a location of the sensor node, wherein the received information comprises receiving a packet including the information indicative of the sensing operation performed by at least one of the plurality of sensor nodes, an identifier, and a counter configured to be incremented each time the packet is transmitted.

19. The sensor node of claim 18, wherein the sensor node is configured to increment the counter, and wherein the sensor node is configured to discard the packet when the incremented value of the counter exceeds a maximum counter value.

20. The sensor node of claim 19, wherein the sensor node is configured to determine, in response to determining that the incremented value of the counter does not exceed the maximum counter value, whether to store the packet based on a random number selected from a predetermined distribution and a number of sensor nodes that have performed sensing operations, and wherein determining whether to store the packet comprises determining whether to store the packet based upon information indicative of a number of sensor nodes in the sensor node network.

21. The sensor node of claim 20, wherein the sensor node is configured to combine the packet with a previously stored packet including information indicative of the at least one previously received packet when the first sensor node determines that the packet is to be stored.

22. The sensor node of claim 21, wherein the sensor node is configured to iteratively access stored packets, randomly select adjacent sensor nodes, and transmit the accessed packets to the randomly selected adjacent sensor nodes to generate a selected distribution of the information indicative of the sensing operation performed by at least one of the sensor nodes.

23. The sensor node of claim 21, wherein the sensor node is configured to generate the selected distribution such that the information indicative of the sensing operation can be retrieved from a number of sensor nodes that is slightly larger than the number of sensor nodes that performed sensing operations used to generate the information.

24. The sensor node of claim 23, wherein the sensor node is configured to estimate the number of source nodes in the source node network based upon a time between a first visit and a second visit associated with the packet.

25. The sensor node of claim 24, wherein the sensor node is configured to estimate the number of sensor nodes that performed sensing operations based upon a time between consecutive visits of packets.
